(19) United States
(12) Patent Application Publication
(10) Pub. No.: US 2025/0149216 A1
(43) Pub. Date: May 8, 2025

(54) TERMINAL CONNECTOR

(71) Applicant: MICRO MOTION, INC., Boulder, CO (US)

(72) Inventors: Gregory Treat LANHAM, Longmont, CO (US); Marcus J. SCHMIDT, Centennial, CO (US)

(73) Assignee: MICRO MOTION, INC., Boulder, CO (US)

(21) Appl. No.: 18/837,395

(22) PCT Filed: Feb. 21, 2022
(86) PCT No.: PCT/US2022/017139

§ 371 Date: Aug. 9, 2024

(51) Int. Cl. H01F 5/04; G01F 1/84; H01F 5/02; H01F 41/076

(52) U.S. Cl. CPC H01F 5/04; H01F 5/02; H01F 41/076; G01F 1/8409

(57) ABSTRACT

A first terminal connector (300) comprises a component member (302) comprising a component member surface (322) with a first terminal post (306) oriented substantially perpendicular to the component member surface (322), and a cap member (304) comprising a cap member surface (324) and a first borehole (310) oriented substantially perpendicular from the cap member surface (324), the first borehole (310) including a bevel volume (328) configured to compress a plurality of windings from one or more wires (332, 334a, 334b) wound around the first terminal post (306) together between the component member surface (322) and the bevel volume (328) when the first terminal post (306) is inserted into the first borehole (310). A second terminal connector (500) comprises a component member (502) comprising a component member surface (522), and a cap member (504) comprising a cap member surface (524), wherein a first groove (550) is positioned on one of the component member surface (522) or the cap member surface (524), a first tongue (556) protruding from the other of the cap member surface (524) or the component member surface (522), and the first tongue (556) including a bevel volume (528) along a ridge of the first tongue (556) configured to compress one or more wires between the first groove (550) and the bevel volume (528) of the first tongue (556) when the first tongue (556) is inserted into the first groove (550).

### TECHNICAL FIELD

The present Application is directed towards terminal connectors, and more particularly, to a terminal connector with a terminal post and a cap.

### BACKGROUND

Vibrating conduit sensors, such as Coriolis mass flowmeters and vibrating densitometers, typically operate by vibrating one or more conduits, then detecting the motion of the one or more vibrating conduits in the presence of a fluid. For example, FIGS. 1A and 1B depict an example Coriolis flowmeter 100. FIG. 1A depicts a frontal view of Coriolis flowmeter 100 with the top of the case cut away, and FIG. 1B depicts a sideview of Coriolis flowmeter 100 with no case.

Example Coriolis flowmeter 100 includes case 102, flow tubes 104, 106, manifolds 108, 110, and spacer 112. Fluid enters the inlet and passes into manifold 108, which divides the fluid between U-shaped conduits 104, 106. After passing through the conduits, the fluid is eventually recombined via manifold 110, and exits the flowmeter via the outlet.

Coriolis flowmeter 100 further includes driver 114 and pickoffs 116 and 118. Driver 114 and pickoffs 116 and 118 each include a coil and a magnet component. In the example embodiment of Coriolis flowmeter 100, the coil and magnet components of driver 114 and pickoffs 116 and 118 are each coupled to an opposing conduit 104, 106 proximate one another. Driver 114 is positioned in a substantially central location along the axial length of conduits 104, 106, and pickoffs 116 and 118 are positioned on opposing sides of driver 114. Driver 114 oscillates the flow tubes in opposition, and pickoffs 116, 118 detect the phase difference, or twist across the flowmeter due to the Coriolis effect produced when a moving fluid is oscillated by driver 114. The phase difference measured via pickoffs 116 and 118 can be used to determine a mass flow or volumetric flow measurement. Alternatively, a frequency determined via either pickoff 116 or 118 can be used to determine a density of the fluid under measurement, as will be understood by those of skill.

Those of skill will understand that Coriolis flowmeter 100 is merely one example of a vibrating conduit sensor. In other embodiments, a Coriolis flowmeter may have one flow tube and one portion of driver 114 and pickoffs 116, 118 may be coupled to a support instead of an opposing flow tube. In further embodiments, a Coriolis flowmeter may have more than two flow tubes, and the driver 114 and pickoffs 116, 118 may be coupled to any combination of flow tubes and supports. Those of skill will further understand that some vibrating densitometers also use driver 114 and pickoff 116, 118 components to drive and sense oscillations of a vibrating member immersed in a fluid.

As stated above, driver 114 and pickoffs 116, 118 typically comprise coil and magnet assemblies. The coil portion, which typically comprises a bobbin spindle with a coil wire wound around the bobbin spindle, is used as an electromagnet to drive oscillations or sense oscillations in the one or more conduits/vibrating members. The ends of the coil wire must be coupled to input/output wires that connect the coil portion of the driver/pickoff to control electronics. In prior art vibrating meters, the ends of each of the coil wire and the input/output wires are soldered or crimped to terminals positioned on the bobbin spindle.

For example, prior art coil portion 200 is depicted in FIG. 2. Coil portion 200 comprises a substantially cylindrical shaped body with a bobbin spindle 202 around which the coil wire may be wound. Prior art coil portion 200 further includes terminals 204 and 206. Coil and/or terminal wires are coupled to terminals 204 and 206 using crimps 208, 210. In embodiments, a vibratory meter with one driver and two pickoffs may require 6-12 wire couplings to terminals on a coil portion 200 electromagnet. Soldering wires to terminals requires additional labor during assembly and can be difficult when the wire becomes increasingly small with smaller meters/components, however. Moreover, there is increasing pressure to remove lead solder from flow meter assemblies. Moreover, crimps 208, 210 can cause pinches in the wire that may create a stress riser, increasing the chances that the wire may fracture and fail. For at least these reasons, getting good contact between the wires and terminals can be complicated with either soldering or crimping. Additionally, once a meter is placed in operation, the meter may be used in a corrosive or thermally dynamic environment, which could further compound any weaknesses in wire connections.

What is needed is a method to couple one or more wires to a terminal that is easy to assemble, robust, and works well with smaller wires.

### SUMMARY

A terminal connector according to a first aspect is provided. The terminal connector comprises a component member and a cap member. The component member comprises a component member surface with a first terminal post oriented substantially perpendicular to the component member surface. The cap member comprises a cap member surface and a first borehole oriented substantially perpendicular from the cap member surface. The first borehole includes a bevel volume configured to compress a plurality of windings from one or more wires wound around the first terminal post together between the component member surface and the bevel volume when the first terminal post is inserted into the first borehole.

A method to assemble a terminal connector according to the first aspect is provided. The terminal connector according to the first aspect comprises a component member and a cap member. The component member comprises a component member surface with a first terminal post oriented substantially perpendicular to the component member surface. The cap member comprises a cap member surface and a first borehole oriented substantially perpendicular from the cap member surface. The first borehole includes a bevel volume configured to compress a plurality of windings from one or more wires wound around the first terminal post together between the component member surface and the bevel volume when the first terminal post is inserted into the first borehole. The method comprises inserting the first terminal post into the first borehole.

A terminal connector according to a second aspect is provided. The terminal connector according to the second aspect comprises a component member and a cap member. The component member comprises a component member surface and the cap member comprises a cap member surface. A first groove is positioned on one of the component member surface or the cap member surface. A first tongue protrudes from the other of the cap member surface or the component member surface. The first tongue includes a bevel volume along a ridge of the first tongue configured to compress one or more wires between the first groove and the bevel volume of the first tongue when the first tongue is inserted into the first groove.

A method to assemble the terminal connector of the second aspect is provided. The terminal connector according to the second aspect comprises a component member and a cap member. The component member comprises a component member surface and the cap member comprises a cap member surface. A first groove is positioned on one of the component member surface or the cap member surface. A first tongue protrudes from the other of the cap member surface or the component member surface. The first tongue includes a bevel volume along a ridge of the first tongue configured to compress one or more wires between the first groove and the bevel volume of the first tongue when the first tongue is inserted into the first groove. The method comprises inserting the first tongue into the first groove.

### ASPECTS

According to an aspect of the terminal connector of the first aspect, the first terminal post may comprise plastic and the first borehole and the first terminal post may be configured to facilitate a heat staked fit when the first terminal post is inserted into the first borehole and heat is applied to the first terminal post.

According to an aspect of the terminal connector of the first aspect, the component member may further comprise a bobbin spindle.

According to an aspect of the terminal connector of the first aspect, the bevel volume may have a conical annular shape.

According to an aspect of the terminal connector of the first aspect, the component member may further comprise a second terminal post oriented substantially perpendicular to the component surface and the cap further comprises a second borehole oriented to be substantially perpendicular from the cap surface and positioned to be inserted onto the second terminal post when the first terminal post is inserted into the first borehole.

According to an aspect of the terminal connector of the first aspect, the terminal connector may further comprise a first terminal wire wound with one or more first terminal wire windings around the first terminal post.

According to an aspect of the terminal connector of the first aspect, the terminal connector may further comprise a first electronics wire with one or more first electronics wire windings around the first terminal post.

According to an aspect of the terminal connector of the first aspect, the first terminal wire may have a first gauge that is lower than a second gauge of the first electronics wire.

According to an aspect of the method of the first aspect, the method may further comprise winding a first terminal wire around the first terminal post to generate one or more first terminal wire windings.

According to an aspect of the method of the first aspect, the method may further comprise winding a first electronics wire around the first terminal post to generate one or more first electronics wire windings.

According to an aspect of the method of the first aspect, the first terminal wire may have a first gauge that is lower than a second gauge of the first electronics wire.

According to an aspect of the method of the first aspect, the component member may further comprise a second terminal post oriented substantially perpendicular to the component member surface and the cap member may further comprise a second borehole oriented to be substantially perpendicular from the cap member surface and wherein inserting the first terminal post into the first borehole may further comprise inserting the second terminal post into the second borehole.

According to an aspect of the method of the first aspect, the component member may further comprise a bobbin spindle and the method may further comprise winding the first electronics wire around the bobbin spindle, and winding the second electronics wire around the second terminal post, wherein the first electronics wire and the second electronics wire are opposing ends of a single electronics wire.

According to an aspect of the method of the first aspect, the method may further comprise applying heat to the first terminal post.

According to an aspect of the terminal connector of the second aspect, the component member may further comprise a second groove positioned on the one of component member surface or the cap member surface, and a second tongue protruding from the other of the component member surface or the cap member surface.

According to an aspect of the terminal connector of the second aspect, the component member may further comprise a bobbin spindle.

According to an aspect of the terminal connector of the second aspect, the bevel volume may form a triangular cross-sectional void when the first tongue is positioned in the first groove.

According to an aspect of the terminal connector of the second aspect, the component member may further comprise a first alignment post and the cap member may further comprise a first alignment borehole, the first alignment post being configured to substantially fill the first alignment borehole when mated together.

According to an aspect of the terminal connector of the second aspect, the first alignment post may comprise plastic and the first alignment post and the first alignment borehole may be configured to facilitate a heat staked fit when the first alignment post is inserted onto the first alignment borehole and heat is applied to the first alignment post.

According to an aspect of the terminal connector of the second aspect, the component member may further comprise a second alignment post and the cap member may further comprise a second alignment borehole, the second alignment post being configured to substantially fill the second alignment borehole when mated together.

According to an aspect of the terminal connector of the second aspect, the terminal connector may further comprise a first terminal wire positioned between the first tongue and the first groove.

According to an aspect of the terminal connector of the second aspect, a first electronics wire may be positioned between the first tongue and the first groove.

According to an aspect of the terminal connector of the second aspect, the first terminal wire may have a first gauge that is lower than a second gauge of the first electronics wire.

According to an aspect of the method of the second aspect, the method may further comprise placing a first terminal wire along the first groove.

According to an aspect of the method of the second aspect, the method may further comprise placing a first electronics wire along the first groove.

According to an aspect of the method of the second aspect, the component member may further comprise a bobbin spindle and the method may further comprise winding the first electronics wire around the bobbin spindle.

According to an aspect of the method of the second aspect, the component member may further comprise a first alignment post and the cap member may further comprise a first alignment borehole, the first alignment post being configured to substantially fill the first alignment borehole when mated together, and the method may further comprise inserting the first alignment post into the first alignment borehole.

According to an aspect of the method of the second aspect, the method may further comprise applying pressure to seat the cap member onto the component member, and applying heat to the first alignment post to generate a heat staked fit between the cap member and the component member.

### BRIEF DESCRIPTION OF THE DRAWINGS

The same reference number represents the same element on all drawings. The drawings are not necessarily to scale.

FIG. 1A depicts a frontal view of Coriolis flowmeter 100, in accordance with an embodiment;

FIG. 1B depicts a side view of Coriolis flowmeter 100, in accordance with an embodiment;

FIG. 2 depicts a prior art coil portion 200;

FIG. 3A depicts a terminal connection 300, in accordance with an embodiment;

FIG. 3B depicts a terminal connection 300, in accordance with an embodiment;

FIG. 3C depicts a terminal connection 300, in accordance with an embodiment;

FIG. 3D depicts a detail of terminal connection 300, in accordance with an embodiment;

FIG. 3E depicts a component member 302, in accordance with an embodiment;

FIG. 3F depicts a component member 302, in accordance with an embodiment;

FIG. 4 depicts a method 400, in accordance with an embodiment;

FIG. 5A depicts a terminal connection 500 in accordance with an embodiment;

FIG. 5B depicts a terminal connection 500 in accordance with an embodiment;

FIG. 5C depicts a terminal connection 500 in accordance with an embodiment; and

FIG. 6 depicts a method 600, in accordance with an embodiment.

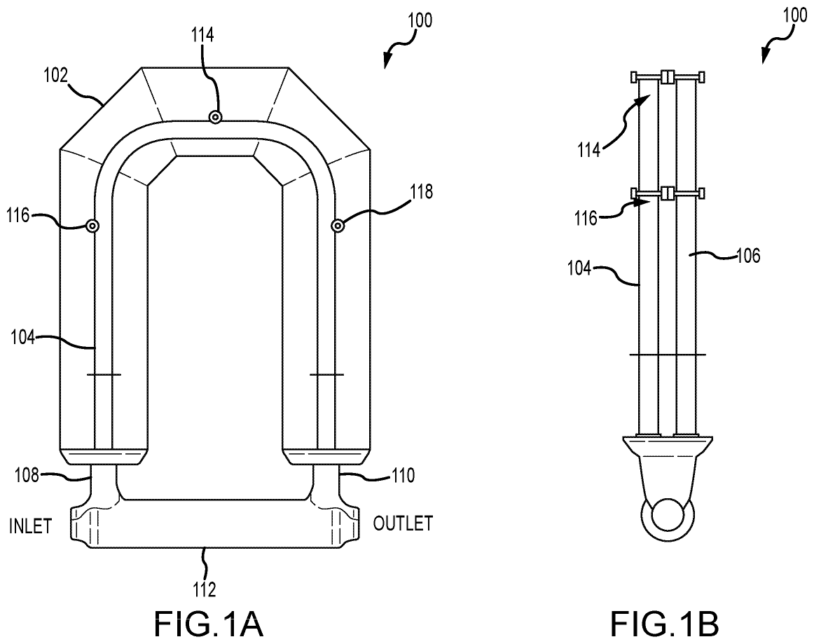

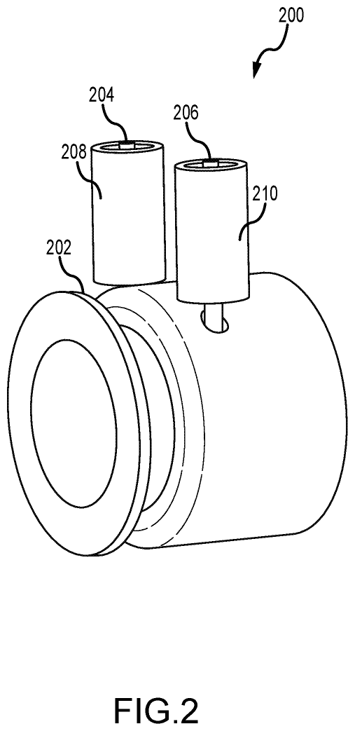

### DETAILED DESCRIPTION

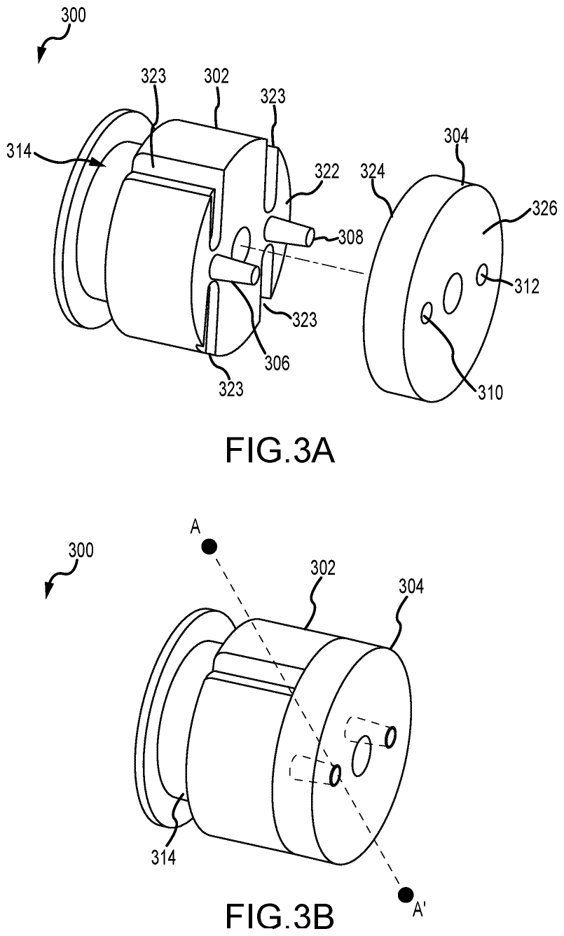

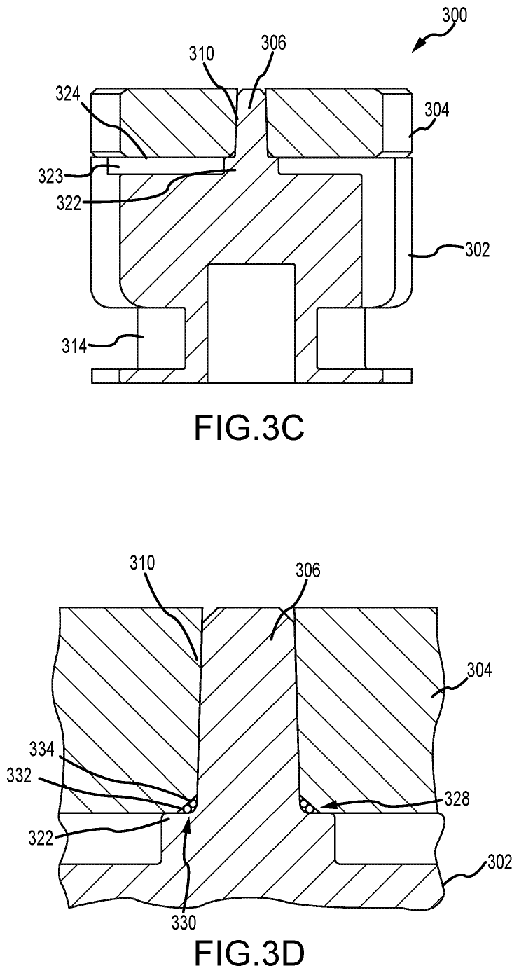

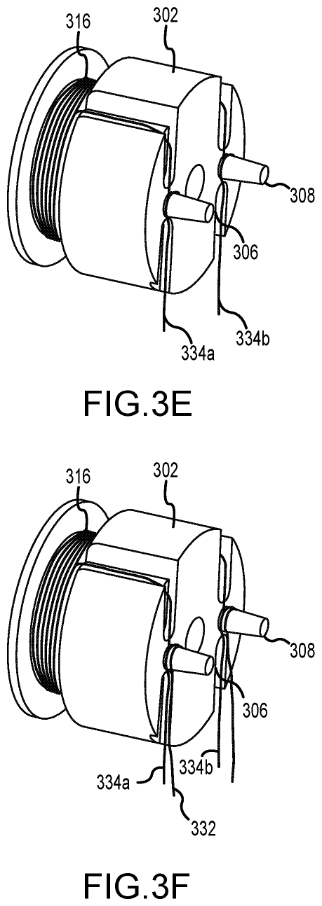

FIGS. 3A-6 and the following description depict specific examples to teach those skilled in the art how to make and use the best mode of the Application. For the purpose of teaching inventive principles, some conventional aspects have been simplified or omitted. Those skilled in the art will appreciate variations from these examples that fall within the scope of the Application. Those skilled in the art will appreciate that the features described below may be combined in various ways to form multiple variations of the Application. As a result, the Application is not limited to the specific examples described below, but only by the claims and their equivalents.

FIGS. 3A-3F depict terminal connector 300, or portions thereof, in accordance with an embodiment of the Application. FIG. 3A depicts an exploded view of disassembled terminal connector 300, and FIG. 3B depicts a perspective view of assembled terminal connector 300. FIG. 3C depicts a cross sectional view of terminal connector 300, as taken through section A-A′ denoted in FIG. 3B. FIG. 3D depicts the detail section noted in FIG. 3C. FIGS. 3E and 3F depict component member 302, FIG. 3E depicting component member 302 wound with a first terminal wire 332, and FIG. 3F depicting component member 302 wound with first terminal wire 332, and at least a first electronics wire 334a.

Terminal connector 300 may comprise any electronic device that may be coupled to one or more input/output wires. In embodiments, the terminal connector 300 may connect an electronic device to a control and/or monitoring electronics or computer. In further embodiments, terminal connector 300 may couple portions of one or more electronic devices to one another.

Terminal connector 300 comprises a component member 302. Component member 302 may comprise an electronic device or component. In embodiments, component member 302 may further comprise a bobbin spindle 314, for example. In embodiments, bobbin spindle 314 may comprise an annular indention in the substantially cylindrical body of component member 302, or a spindle member with or without flanges. In further embodiments, however, bobbin spindle 314 may comprise any format or shape known to those of skill.

Component member 302 further comprises a component member surface 322, which may be best seen in FIG. 3A. In the embodiment of terminal connector 300, component member surface 322 comprises a substantially planar circular surface at one end of a substantially cylindrically shaped component member body. This is not intended to be limiting, however. In embodiments, component member surface 322 may comprise any shape that may be coupled to cap member 304.

In the example embodiment of component member 302, component member surface 322 includes four cutouts for wire passages 323. Wire passages 323 may allow a passage through component member surface 322 for wires. In embodiments, wire passages 323 may allow wires coupled to one or more terminal posts to pass through the body of component member 302, for example to be wound around bobbin spindle 314. In embodiments, wire passages 323 may route input/external wires through the body of component member 302. While four wire passages 323 with elongated shapes are depicted in component member surface 322 in FIGS. 3A-3F, those of skill will understand that these are not intended to be limiting. In embodiments, terminal connector 300 may comprise zero wire passages 323, or any number of wire passages 323, which may take any shape.

Component member 302 further comprises a first terminal post 306 oriented to be substantially perpendicular to component member surface 322. By substantially perpendicular, what is meant is that the axis of first terminal post 306 is oriented to be within 0, 5, 10, 15, or 20 degrees of a normal to component member surface 322. First terminal post 306 may comprise any cylinder, tab, or extension which may be used to secure or electrically couple any wire related to terminal connector 300.

In embodiments, component member 302 may be fabricated from metal, such as copper or aluminum. In further examples, however, it may be fabricated from plastic or any other substance known to those of skill. In embodiments, first terminal post 306 may be fabricated from metal or plastic, with other portions of component member 302 being fabricated from the same or a different material. In embodiments where first terminal post 306 comprises metal, this may help facilitate an electrical connection between wires coupled between component member 302 and cap member 304. In embodiments where first terminal post 306 comprises plastic, this may help facilitate a heat-staking coupling between component member 302 and cap member 304, as further described below. In further embodiments, first terminal post 306 may comprise a combination of metal and plastic, as will be understood by one of skill.

Terminal connector 300 further comprises a cap member 304. Cap member 304 may comprise any cover operable to couple to post 306 and apply pressure to wires wound around the terminal posts of component member 302. Cap member 304 comprises a cap member surface 324 (back side of cap member 304 in FIG. 3A, see also FIG. 3C). In the embodiment of terminal connector 300, the cap member surface 324 comprises a substantially planar circular surface at the component member-facing end of a substantially cylindrically shaped cap member body. This is not intended to be limiting, however. In embodiments, cap member surface 324 may comprise any shape that may be coupled to component member 302.

In embodiments, cap member surface 324 and component member surface 322 may be configured to come into contact when terminal connector 300 is completely assembled. In embodiments, cap member surface 324 and component member surface 322 may be configured to come into close proximity when terminal connector 300 is completely assembled, but not be in actual contact. In such embodiments, cap member surface 324 and component member surface 322 may be configured to provide minimal space between component member 302 and cap member 304 when terminal connector 300 is assembled.

Cap member 304 further comprises a first borehole 310 oriented substantially perpendicular from the cap member surface 324. By substantially perpendicular, what is meant is that the axis of first borehole 310 is oriented to be within 0, 5, 10, 15, or 20 degrees of the normal to cap member surface 324. First borehole 310 passes through cap member surface 324. In embodiments, first borehole 310 may or may not pass all the way through opposing surface 326 at the end of cap member 304.

In FIG. 3D it may be seen that first borehole 310 includes a bevel volume 328 between first borehole 310, first terminal post 306 and component member surface 322. Bevel volume 328 comprises an annular portion of material subtracted between the intersection of first borehole 310 and component member surface 322. Bevel volume 328 may comprise any shape of control volume configured to contain or compress a plurality of windings 330 from one or more wires wound around first terminal post 306 together between component member surface 322, first borehole 310, and first terminal post 306 when first terminal post 306 is inserted into first borehole 310. In embodiments, bevel volume 328 may apply enough pressure to provide reliable contact between one or more wire windings contained within bevel volume 328 or between one or more wire windings and component member 302. In embodiments, first bevel volume 328 may be configured to avoid damaging the one or more windings of the wires.

In embodiments, bevel volume 328 has a conical annular shape, which may best be seen in FIG. 3D. The conical annular shape has a cross section of a triangle on each side of terminal post 306. Those of skill will recognize that the conical annular shape may provide just enough volume for wires of two different gauges wound together to be compressed, but not deformed when cap member 304 is installed. The conical annular shape may further allow for advantages when fabricating cap member 304 during a plastic injection mold process, facilitating easier removal of cap member 304 from its mold.

The conical annular shape depicted in FIG. 3D is not intended to be limiting. Those of skill will readily understand that bevel volume 328 may be configured to include any cross-sectional shape suitable to contain the desired gauge(s) of wire(s) with the desired number of wire wrap(s).

In embodiments, the portion of terminal post 306 forming the periphery of bevel volume 328 may be fabricated from metal to facilitate connection between the wires coupled therein.

For example, it may be seen in FIG. 3D that terminal connector 300 may further comprise plurality of windings 330. In embodiments, plurality of windings 330 may include a first terminal wire 332 with one or more first terminal wire windings around first terminal post 306. In embodiments, first terminal wire 332 may connect the electronics of component member 302 to external electronics.

In embodiments, plurality of windings 330 may further comprise a first electronics wire 334a with one or more first electronics wire windings around first terminal post 306. In embodiments, first electronics wire 334a may comprise a coil wire or any other wire associated with component member 302.

In embodiments, first terminal wire 332 may have a first gauge that is lower than a second gauge of first electronics wire 334a. This may be the case, for example, when a higher gauge wire is used for the coil wire and a lower gauge wire is used for the input/output wire. In embodiments, the coil wire may be between 34-46 gauge and the input/output wire may be 32 gauge.

In embodiments, first electronics wire 334a with the higher gauge may be wound between component member 302 and first terminal wire 332 with a lower gauge. A conical annular shaped bevel volume 328 may provide an improved fit for this particular configuration, providing reliable electrical contact between first electronics wire 334a and first terminal wire 332 having different gauges, while also providing each wire a different respective volume of space to avoid crimping and damage.

In embodiments, component member 302 may further comprise a second terminal post 308 oriented substantially perpendicular to component member surface 322. Second terminal post 308 may be used to couple a second terminal wire 335 to component member 302, as may be seen in FIG. 3F.

In embodiments, each of first and second terminal posts 306, 308 may be paired with a separate cap member 304. In further embodiments, however, cap member 304 may comprise a second borehole 312 oriented to be substantially perpendicular from cap member surface 324 and positioned to be coupled around second terminal post 308 when first terminal post 306 is inserted into first borehole 310. In embodiments, second terminal post 308 may include similar features to first terminal post 306, and second borehole 312 may include similar features to first borehole 310.

In embodiments, first borehole 310 and first terminal post 306 may be configured to facilitate a heat staked fit when the first terminal post 306 is inserted into the first borehole 310 and heat is applied to the first terminal post 306. In such embodiments, cap member 304 may be fabricated from plastic.

A heat staked fit may comprise applying heat to first terminal post 306 of component member 302 until terminal post 306 becomes at least partially melted around first borehole 310. In embodiments where component member 302 further comprises second terminal post 308, heat may also be applied to second terminal post 308 as well. In embodiments, the heat staked fit may further comprise applying pressure between component member 302 and cap member 304 so that the members move closer together during the melt operation. The pressure and applied heat allow the melted area(s) of terminal post 306, 308 to reform around one or more boreholes 310, 312. In this way, a heat staked fit may join component member 302 to cap member 304 in a robust way.

In embodiments, first terminal post 306 and first borehole 310 may be substantially cylindrical in shape. In other embodiments, first terminal post 306 and first borehole 310 may include mildly cone-shaped components designed to fit snuggly together when fully inserted. In further embodiments, however, first terminal post 306 and first borehole 310 may comprise any elongated shapes configured to fit snuggly together when pressure is applied between component member 302 and cap member 304.

In further embodiments, first borehole 310 and terminal post 306 may be coupled together via a pressure or pressure fit. In further embodiments, a fastener or an adhesive may be used to couple component member 302 to cap member 304. In embodiments, a silicone adhesive may be used. In embodiments, any combination of heat staking, adhesive, and fastener may be used to couple component member 302 to cap member 304. In further embodiments, component member 302 and cap member 304 may be coupled together via any method known to those of skill in the art.

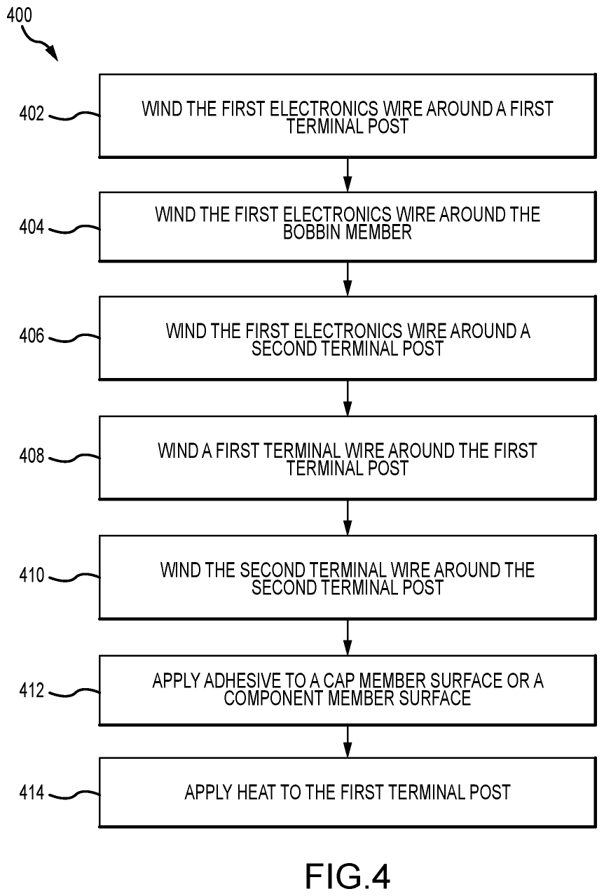

FIG. 4 depicts method 400 for assembling terminal connection 300 according to an embodiment. Method 400 includes step 412. In step 412, first terminal post 306 is inserted into first borehole 310, as described above.

In embodiments, method 400 may include further steps. For example, method 400 may include any combination of steps 402-411 or 414.

In embodiments, method 400 may further comprise step 402. In step 402, first electronics wire 334a may be wound around first terminal post 306. For example, FIG. 3E depicts first electronics wire 334a wound around first terminal post 306.

In embodiments, method 400 may further comprise step 404. In step 404, first electronics wire 334a may be wound around bobbin spindle 314. This may allow component member 302 to be used as an electromagnet, as described above. FIG. 3E also depicts first electronics wire 334a also wound around first terminal post 306.

In embodiments, method 400 may further comprise step 406. In step 406, first electronics wire 334a may be wound around second terminal post 308. For example, FIG. 3E also depicts second electronics wire 334b wound around second terminal post 308.

In embodiments of step 406, second electronics wire 334b may be wound around second terminal post 308 instead of first electronics wire 334a, as explained above.

In embodiments, method 400 may further comprise step 408. In step 408, a first terminal wire 332 may be wound around the first terminal post 306 to generate one or more first terminal wire windings, as described above. For example, FIG. 3E depicts first terminal wire 332 wound once around first terminal post 306.

In embodiments, method 400 may further comprise step 410. In step 410, a second terminal wire 335 may be wound around second terminal post 308, as depicted in FIG. 3F. This configuration may be used to create an electromagnet that connects to two input/output wires, as described above.

In embodiments, first electronics wire 334a and second electronics wire 334b may comprise opposing ends of the same electronics wire. For example, when component member 302 comprises bobbin spindle 314, first electronics wire 334a and second electronics wire 334b may comprise opposite ends of the wire used to wind bobbin spindle 314.

In embodiments, method 400 may further comprise step 412. In step 412, an adhesive may be applied to a cap member surface 324 or a component member surface 322, as described above.

In embodiments, method 400 may further comprise step 414. In step 414, heat may be applied to first terminal post 306, as described above.

In embodiments of terminal connection 300 that comprise second terminal post 308, method 400 may further comprise inserting second terminal post 308 into second borehole 312. In embodiments, method 400 may further comprise applying heat to second terminal post 308, as described above.

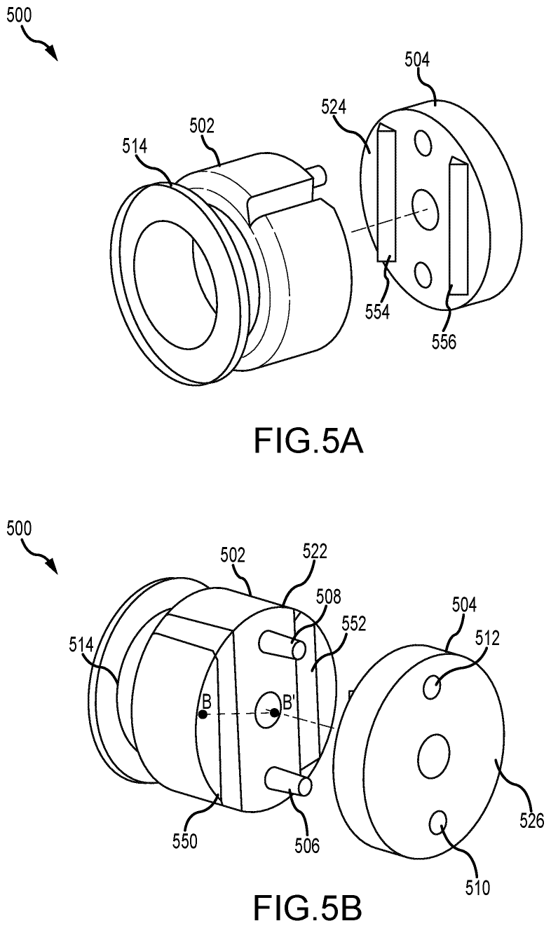

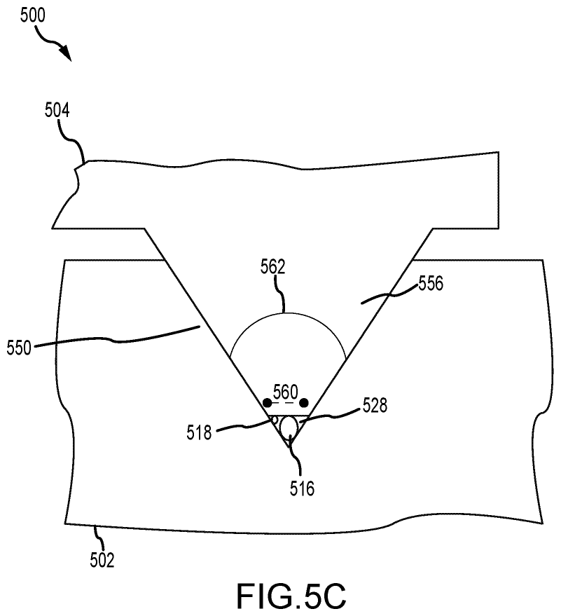

FIGS. 5A-5C depict an additional terminal connection 500, in accordance with an embodiment. FIG. 5A and 5B depict exploded views of disassembled terminal connector 500, and FIG. 5C depicts a cross-sectional view of assembled terminal connector 500, as taken through section B-B′ denoted in FIG. 5B.

Like terminal connector 300, terminal connector 500 may comprise any electronic device that may be coupled to one or more terminal wires. In embodiments, terminal connector 500 may connect an electronic device to a control and/or monitoring electronics or computer. In further embodiments, terminal connector 500 may couple portions of one or more electronic devices to one another.

Terminal connector 500 comprises a component member 502. Component member 502 may comprise an electronic component. In embodiments, component member 502 may further comprise a bobbin spindle 514, for example. In embodiments, bobbin spindle 514 may comprise an annular depression in the substantially cylindrical body of component member 502.

Component member 502 further comprises a component member surface 522. Component member surface 522 may be best seen in FIG. 5B. In the embodiment of terminal connector 500, component member surface 522 comprises a substantially planar circular surface at one end of a substantially cylindrically shaped component member body. This is not intended to be limiting, however. In embodiments, component member surface 522 may comprise any shape that may be coupled to cap member 504.

Terminal connector 500 further comprises a cap member 504. Cap member 504 may comprise any cover operable to couple to component member 502 to provide a wire connection. Cap member 504 comprises a cap member surface 524. In the embodiment of terminal connector 500, the cap member surface 524 comprises a substantially planar circular surface at the component member-facing end of a substantially cylindrically shaped cap member body. This is not intended to be limiting, however. In embodiments, cap member surface 524 may comprise any shape that may be coupled to component member 502.

Terminal connector 500 further comprises a first groove 550 and a first tongue 556. First groove 550 may be positioned on one of component member surface 522 or cap member surface 524, while first tongue 556 may be positioned on the other of the component member surface 522 or cap member surface 524, so that first groove 550 and first tongue 556 line up in opposition to one another when terminal connector 500 is assembled.

First groove 550 comprises an elongated, linear depression in the surface in which it is positioned. In FIGS. 5A-5C, it may be seen that example first groove 550 is substantially straight along its longitudinal length and triangular in cross section traverse to its longitudinal direction. This is not intended to be limiting, however. In embodiments, first groove 550 may follow a curved path. In embodiments, first groove 500 may traverse an entire surface from end-to-end of terminal connector 500, or only a short section of terminal connector 500.

While first groove 550 is depicted as comprising a triangular cross section, this is also not intended to be limiting. In further embodiments, the first groove 550 may comprise a rectangular or a semi-circular cross sectional area. Those of skill will readily understand that any other shape or configuration of first groove 550 is possible that allows a wire to be coupled therein.

First tongue 556 comprises an elongated protrusion in the surface from which is positioned that substantially follows the track of first groove 550. In the embodiment of terminal connector 500, example first tongue 556 is substantially straight and linear along its longitudinal length and triangular in cross section traverse to its longitudinal direction. Those of skill will understand that, as described above, the straight embodiment is not intended to be limiting.

First tongue 556 includes a beveled portion 528 that follows along the tip of the protrusion it makes from the surface in which it is placed. Beveled portion 528 is configured to compress one or more wires between first groove 550 and component member 502 is coupled to cap member 504.

In embodiments, beveled portion 528 may truncate the cross-sectional shape of first tongue 556 in the axial direction. In embodiments, beveled portion 528 may form a triangular-shaped cross sectional control volume, or void between first tongue 556 and first groove 550 when cap member 504 is coupled to component member 502, as may be seen in FIG. 5C.

Those of skill will readily understand that the example of terminal connector 500 is not intended to be limiting. In embodiments, the shape of beveled portion 528 may comprise any suitable cross-sectional shape operable to compress wires between first groove 550 and first tongue 556. For example, beveled portion 528 may further comprise a rectangular or semi-circular cross-sectional area.

In embodiments, component member 502 may be fabricated from metal, such as copper or aluminum. In embodiments, component member 502 may be fabricated with plastic or any other material known to those of skill. In embodiments, portions of component member 502 may comprise different materials. For example, first tongue 556 may be formed from metal to facilitate a connection between wires coupled therein, while the rest of component member 502 or cap member 504 may comprise plastic.

By coupling first groove 550 to first tongue 556, terminal connector 500 may provide a connection between a wire and either an electronic device or another wire.

In embodiments, first tongue 556 and first groove 550 may comprise any combination of metals, plastics, or resins. In further embodiments, first tongue 556 and first groove 550 may comprise any materials known to those of skill.

In embodiments, terminal connector 500 may further comprise a second groove 552 positioned on the one of component member surface 522 or the cap member surface 524 and a second tongue 554 protruding from the other of the component member surface 522 or the cap member surface 524. Second groove 552 and second tongue 554 may be similar to first tongue 556 and first groove 550, as described above. In further embodiments, however, second tongue 554 and second groove 552 may comprise different shapes or layouts to first tongue 556 and first groove 550.

Second groove 552 and second tongue 554 may serve to couple a second terminal wire to a second electronics wire, similar to second terminal post 308 and second borehole 312 described above. In embodiments, the first electronics wire and the second electronics wire may comprise opposing ends of a single electronics wire. In embodiments, that single electronics wire may be further wound around bobbin spindle 314.

In embodiments, component member 502 further comprises a first alignment post 506 oriented to be substantially perpendicular to component member surface 522. By substantially perpendicular, what is meant is that the axis of first alignment post 506 is oriented within 0, 5, 10, 15, or 20 degrees of the normal to component member surface 522. First alignment post 506 may comprise any cylinder, tab, or extension which may be used to align or couple component member 502 to cap member 504.

Cap member 504 further comprises a first alignment borehole 510, first alignment post 506 being configured to substantially fill first alignment borehole 510 when inserted therein. In embodiments, first alignment borehole 510 may or may not pass all the way through opposing surface 526 of cap member 504.

In embodiments, first alignment post 506 and first alignment borehole 510 may be configured to facilitate a heat staked fit when first alignment post 506 is inserted into first alignment borehole 510 and heat is applied to first alignment post 506. In embodiments, first alignment post 506 may comprise plastic to facilitate a heat-staked fit, as described above.

In embodiments, component member 502 may further comprise a second alignment post 508 similar to first alignment post 506, and the cap member 504 may further comprise a second alignment borehole 512 similar to first alignment borehole 510. Second alignment post 508 may be configured to substantially fill second alignment borehole 512 when mated together.

As may be seen in FIG. 5C, in embodiments terminal connector 500 may further comprise a first terminal wire 516 positioned between first tongue 556 and first groove 550.

In further embodiments, a first electronics wire 518 may be positioned between the first tongue 556 and the first groove 550.

In embodiments, first terminal wire 516 may have a first gauge that is lower than a second gauge of first electronics wire 518.

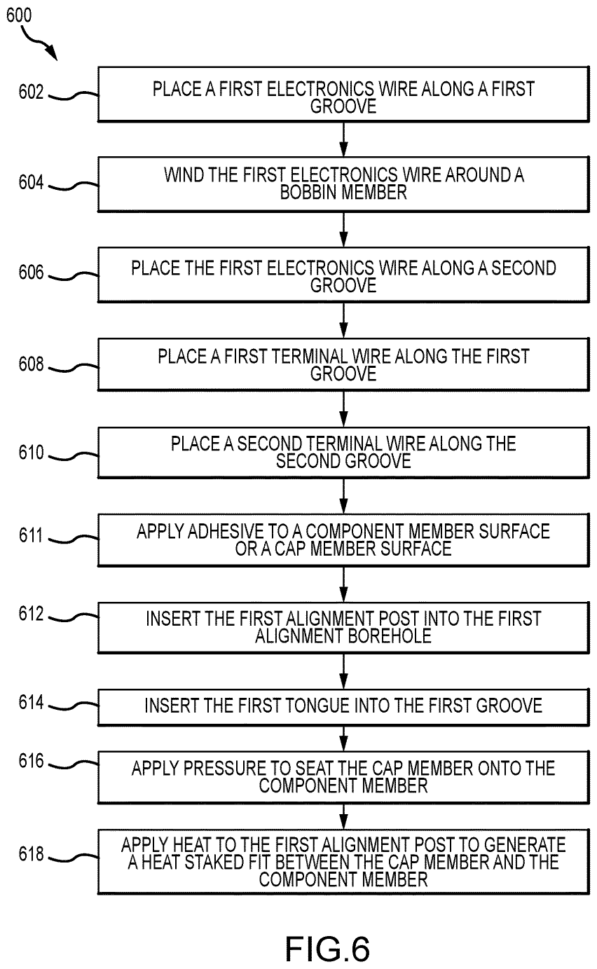

FIG. 6 depicts method 600 for assembling terminal connection 500 according to an embodiment. Method 600 includes step 614. In step 614, first tongue 556 is inserted into first groove 550.

In embodiments, method 600 may comprise further steps. For example, method 600 may comprise any combination of steps 602-612 or 616-618.

In embodiments, method 600 may further comprise step 602. In step 602, first electronics wire 518 may be placed along first groove 550. This may allow terminal connector 500 to electrically couple first terminal wire 516 and first electronics wire 518 together securely, as described above.

In embodiments where component member 502 comprises an electromagnet, method 600 may further comprise step 604. In step 604, first electronics wire 518 may be wound around bobbin spindle 514, as described above.

In embodiments, method 600 may further comprise step 606. In step 606, first electronics wire 518 may be placed in a second groove 552.

In embodiments of step 606, a second electronics wire may be placed in second groove 552 instead of first electronics wire 518.

In embodiments, method 600 may further comprise step 608. In step 608, a first terminal wire 516 may be placed along first groove 550, as described above.

In embodiments, method 600 may further comprise step 610. In step 610, a second terminal wire may be placed along second groove 552, as described above.

In embodiments, method 600 may further comprise step 611. In step 611, an adhesive may be applied to a cap member surface 524 or a component member surface 522, as described above.

In embodiments, method 600 may further comprise step 612. In step 612, first alignment post 506 may be inserted into first alignment borehole 510, as described above.

In embodiments, method 600 may further comprise step 616. In step 616, pressure may be applied to seat cap member 504 onto component member 502, as described above.

In embodiments, method 600 may further comprise step 618. In step 618, heat may be applied to first alignment post 506 to generate a heat staked fit between cap member 504 and component member 502, as is further described above.

The embodiments of this application may allow for a robust, easy to assemble, solderless terminal connection. The embodiments provide a terminal connection capable of coupling wires to one another or an electronics component without damaging the wires themselves. The embodiments provide a terminal connection which is particularly well suited to connecting wires of different gauges together. The embodiments provide a terminal connection which is particularly suitable for use in a driver or pickoff electromagnet coil for a vibratory flowmeter.

The detailed descriptions of the above examples are not exhaustive descriptions of all examples contemplated by the inventors to be within the scope of the Application. Indeed, persons skilled in the art will recognize that certain elements of the above-described examples may variously be combined or eliminated to create further examples, and such further examples fall within the scope and teachings of the Application. It will also be apparent to those of ordinary skill in the art that the above-described examples may be combined in whole or in part to create additional examples within the scope and teachings of the Application. Accordingly, the scope of the Application should be determined from the following claims.

We claim:

1. A terminal connector (300) comprising:
a component member (302) comprising a component member surface (322) with a first terminal post (306) oriented substantially perpendicular to the component member surface (322); and
a cap member (304) comprising a cap member surface (324) and a first borehole (310) oriented substantially perpendicular from the cap member surface (324),
wherein the first borehole (310) includes a bevel volume (328) configured to compress a plurality of windings from one or more wires (332, 334a, 334b) wound around the first terminal post (306) together between the component member surface (322) and the bevel volume (328) when the first terminal post (306) is inserted into the first borehole (310).

2. The terminal connector (300) as claimed in claim 1, wherein the first terminal post (306) comprises plastic and the first borehole (310) and the first terminal post (306) are configured to facilitate a heat staked fit when the first terminal post (306) is inserted into the first borehole (310) and heat is applied to the first terminal post (306).

3. The terminal connector (300) of claim 1, wherein the component member (302) further comprises a bobbin spindle (314).

4. The terminal connector (300) of claim 1, wherein the bevel volume (328) has a conical annular shape.

5. The terminal connector (300) of claim 1, wherein the component member (302) further comprises a second terminal post (308) oriented substantially perpendicular to the component surface and the cap further comprises a second borehole (312) oriented to be substantially perpendicular from the cap surface and positioned to be inserted onto the second terminal post (308) when the first terminal post (306) is inserted into the first borehole (310).

6. The terminal connector (300) of claim 1, further comprising:
a first terminal wire (332) wound with one or more first terminal wire windings around the first terminal post (306).

7. The terminal connector (300) as claimed in claim 6, further comprising:
a first electronics wire (334a) with one or more first electronics wire windings around the first terminal post (306).

8. The terminal connector (300) as claimed in claim 7, wherein the first terminal wire (332) has a first gauge that is lower than a second gauge of the first electronics wire (334a).

9. A method to assemble the terminal connector (300) as claimed in claim 1, the method comprising:
inserting the first terminal post (306) into the first borehole (310).

10. The method as claimed in claim 9, further comprising:
winding a first terminal wire (332) around the first terminal post (306) to generate one or more first terminal wire windings.

11. The method as claimed in 10, further comprising:
winding a first electronics wire (334a) around the first terminal post (306) to generate one or more first electronics wire windings.

12. The method as claimed in 11, wherein the first terminal wire (332) has a first gauge that is lower than a second gauge of the first electronics wire (334a).

13. The method as claimed in claim 9, wherein the component member (302) further comprises a second terminal post (308) oriented substantially perpendicular to the component member surface (322) and the cap member (304) further comprises a second borehole (312) oriented to be substantially perpendicular from the cap member surface (324) and wherein inserting the first terminal post (306) into the first borehole (310) further comprises inserting the second terminal post (308) into the second borehole (312).

14. The method as claimed in claim 13, wherein the component member (302) further comprises a bobbin spindle (314) and the method further comprises: winding the first electronics wire (334a) around the bobbin spindle (314); and winding the second electronics wire (334b) around the second terminal post (308), wherein the first electronics wire (334a) and the second electronics wire (334b) are opposing ends of a single electronics wire.

15. The method as claimed in claim 9, further comprising:
applying heat to the first terminal post (306).

16. A terminal connector (500) comprising:
a component member (502) comprising a component member surface (522); and
a cap member (504) comprising a cap member surface (524),
wherein a first groove (550) is positioned on one of the component member surface (522) or the cap member surface (524), a first tongue (556) protruding from the other of the cap member surface (524) or the component member surface (522), and the first tongue (556) includes a bevel volume (528) along a ridge of the first tongue (556) configured to compress one or more wires between the first groove (550) and the bevel volume (528) of the first tongue (556) when the first tongue (556) is inserted into the first groove (550).

17. The terminal connector (500) of claim 16, wherein the component member (502) further comprises:
a second groove (552) positioned on the one of component member surface (522) or the cap member surface (524); and
a second tongue (554) protruding from the other of the component member surface (522) or the cap member surface (524).

18. The terminal connector (500) of claim 16, wherein the component member (502) further comprises a bobbin spindle (514).

19. The terminal connector (500) of claim 16, wherein the bevel volume (528) forms a triangular cross-sectional void when the first tongue (556) is positioned in the first groove (550).

20. The terminal connector (500) of claim 16, wherein the component member (502) further comprises a first alignment post (506) and the cap member (504) further comprises a first alignment borehole (510), the first alignment post (506) being configured to substantially fill the first alignment borehole (510) when mated together.

21. The terminal connector (500) of claim 20, wherein the first alignment post (506) comprises plastic and the first alignment post (506) and the first alignment borehole (510) are configured to facilitate a heat staked fit when the first alignment post (506) is inserted onto the first alignment borehole (510) and heat is applied to the first alignment post (506).

22. The terminal connector (500) of claim 16, wherein the component member (502) further comprises a second alignment post (508) and the cap member (504) further comprises a second alignment borehole (512), the second alignment post (508) being configured to substantially fill the second alignment borehole (512) when mated together.

23. The terminal connector (500) of claim 16, further comprising:
a first terminal wire (516) positioned between the first tongue (556) and the first groove (550).

24. The terminal connector (500) as claimed in claim 23, further comprising:
a first electronics wire (518) positioned between the first tongue (556) and the first groove (550).

25. The terminal connector (500) as claimed in claim 24, wherein the first terminal wire (516) has a first gauge that is lower than a second gauge of the first electronics wire (518).

26. A method to assemble the terminal connector (500) as claimed in claim 16, the method comprising:
inserting the first tongue (556) into the first groove (550).

27. The method as claimed in claim 26, further comprising:
placing a first terminal wire (516) along the first groove (550).

28. The method as claimed in 27, further comprising:
placing a first electronics wire (518) along the first groove (550).

29. The method as claimed in claim 28, wherein the component member (502) further comprises a bobbin spindle (514) and the method further comprises:
winding the first electronics wire (518) around the bobbin spindle (514).

30. The method as claimed in claim 26, wherein the component member (502) further comprises a first alignment post (506) and the cap member (504) further comprises a first alignment borehole (510), the first alignment post (506) being configured to substantially fill the first alignment borehole (510) when mated together, and the method further comprises:
inserting the first alignment post (506) into the first alignment borehole (510).

31. The method as claimed in claim 30, further comprising:
applying pressure to seat the cap member (504) onto the component member (502); and
applying heat to the first alignment post (506) to generate a heat staked fit between the cap member (504) and the component member (502).
